(19) United States
(12) Patent Application Publication
(10) Pub. No.: US 2003/0137491 A1
(43) Pub. Date: Jul. 24, 2003

(54) Computer mouse with multimedia hot-keys

(76) Inventor: Wen-Hsiu Kuo, Sanchung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/052,542

(22) Filed: Jan. 23, 2002

(51) Int. Cl. G09G 5/08

(52) U.S. Cl. 345/163

(57) ABSTRACT

A mouse input device with multimedia hotkeys is provided. The mouse input device includes a mouse body, a plurality of input portions for detecting the movement of the mouse body, a mouse motion tracking mechanism for moving the mouse body, a circuit board for controlling the mouse operations, a periphery interface for transmitting data processed by the circuit board to a computer, and at least one multimedia hotkey. When the multimedia hotkey is depressed, the data encoded by the circuit board are transmitted to the computer through the periphery interface for executing associated multimedia programs.

### BACKGROUND OF THE INVENTION

1. Field of the Invention

The field of present invention relates to the feature of a mouse device, and more particularly, to a mouse device with built-in multimedia and/or internet hot keys.

2. Description of the Prior Art

The mouse is an essential input device for contemporary computer operations. Users may select icon function by the cursor, grip the mouse body under their palms to slide, and depress the buttons by their fingers. The cursor is used to indicate locations of icon according to the movement of the mouse body.

Keyboard is another important input device for a computer user. As the operating system, such as Windows, and application software become more and more powerful, the access to internet and has become more and more convenient. Some keyboard manufacturers provide computer keyboards with built-in hotkeys, but, however, none of them provide a mouse device with pre-setup function hotkeys for the access to internet and multimedia operations.

### SUMMARY OF THE INVENTION

Therefore it is a primary object of the present invention to provide a new mouse input device including pre-setup multimedia/internet hotkeys.

According to the claimed invention, the mouse input device includes a mouse body, a plurality of input portions for detecting the movement of the mouse body and selecting to execute application programs, a mouse motion tracking mechanism for moving cursor of the mouse body, a circuit board for controlling the mouse operation, a periphery interface for transmitting data to the computer, and at least one multimedia hotkey. When the multimedia hotkey is depressed, data encoded by the circuit board are proceeded and transmitted to the computer to execute associated multimedia programs.

It is to be understood that both the forgoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

FIG. 1 is a perspective view of a computer mouse according to one preferred embodiment of this invention.

FIG. 2 is a flow chart illustrating the operating process of the mouse in accordance with the present invention.

### DETAILED DESCRIPTION OF THE PREFERRED EMBODIMENT

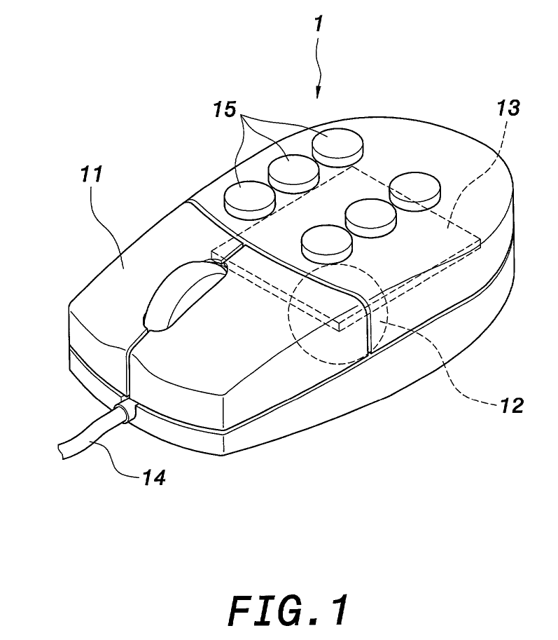

Please refer to FIG. 1. FIG. 1 is a perspective view of a computer mouse according to one preferred embodiment of this invention. As shown in FIG. 1, the computer mouse includes a mouse body 1, a plurality of input portions 11, a mouse motion tracking mechanism 12, a circuit board 13, a periphery interface 14, and a plurality of multimedia hotkeys 15.

The input portion 11 includes at least one general function key and a wheel axis as known in the art. A user grips the mouse body 1 under his palm and rests his index or middle finger on the general function keys. Afterward, the computer user can employ his wrist to move the cursor on the screen, and to execute relative application programs when the cursor is moved to the icon and the function key is depressed.

The mouse motion tracking mechanism 12 may include a wheel ball or optical lens. The movement of the mouse may be detected by, for example, the combination of the wheel ball and IR_PTR or the optical lens and an optical sensor of the interface device.

The circuit board 13 is mounted within the mouse body 1. The circuit board 13 has a microcontroller unit (not shown) for data encoding, signal processing, and mouse operation control. When the mouse body 1 is moved to an intended icon on the computer screen by the cursor and the input portion 11 detects general function keys are pressed, these signals will be processed by the circuit board 13 and sent to a computer (not shown either).

The periphery interface 14 can be a serial type connector (as shown in FIG. 1), PS2 connector, or USB connector. Alternatively, the periphery interface 14 may be a wireless or wired interface. The wireless interface may be a radio-frequency or infrared communication module. It is known that such wireless transmission has to incorporate with a receiver connected to the computer for relaying corresponding signals and data decoding. The main purpose of the periphery interface 14 is to transmit data processed and decoded by the circuit board 13 to the computer.

The multimedia hotkeys 15 are disposed on the top surface of the mouse body 1. When the user presses one of the multimedia hotkeys 15, data encoded and processed by the circuit board 13 are transmitted to the computer through the periphery interface 14 for executing associated multimedia programs.

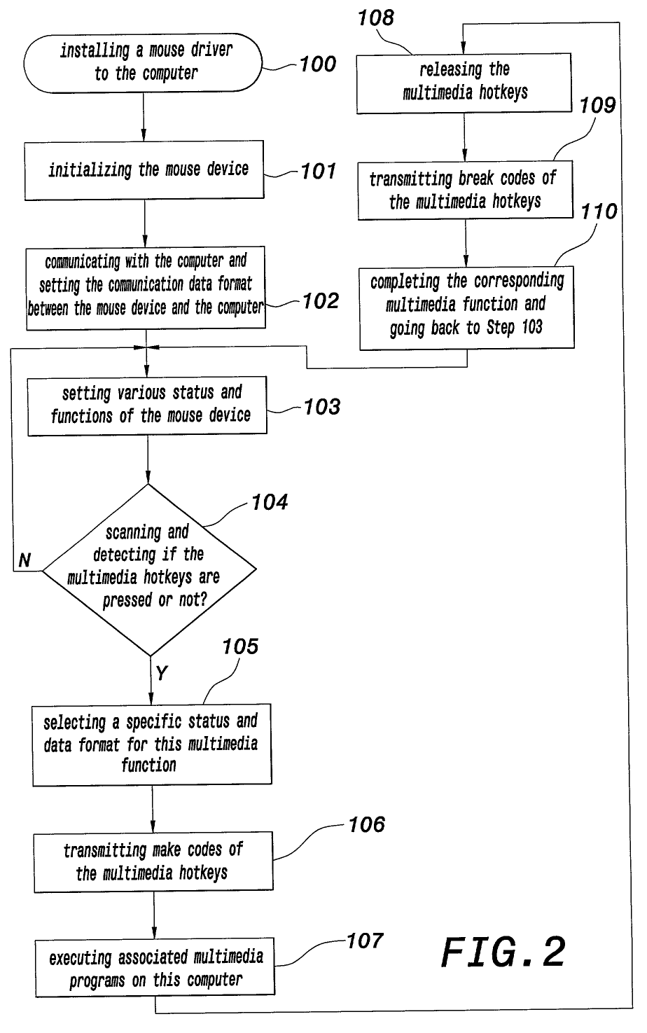

Please refer to FIG. 2. FIG. 2 is a flow chart illustrating the operating process of the mouse in accordance with the present invention. The operating process including following steps:

Step 100: installing a mouse driver in the computer for the first time;

Step 101: initializing the mouse device;

Step 102: communicating with the computer and setting the communication data format between the mouse device and the computer;

Step 103: setting various status and functions of the mouse device;

Step 104: scanning and detecting if the multimedia hotkeys are pressed or not? If yes, go to Step 105, if not, back to Step 103;

Step 105: setting a specific status and data format for the multimedia function;

Step 106: transmitting make codes when any a multimedia hotkey is pressed;

Step 107: executing associated multimedia program on this computer;

Step 108: releasing the multimedia hotkey;

Step 109: transmitting break codes when any multimedia hotkey is released; and

Step 110: completing the function of the multimedia hotkey and going back to Step 103.

In contrast to the prior art, this invention provides a mouse device having pre-setup built-in hotkeys for executing multimedia programs directly. Furthermore, the user can link internet, receive or send E-mails, and play VCDs/DVDs by just pressing these hotkeys and not by using the keyboard anymore.

Those skilled in the art will readily observe that numerous modification and alterations of the device may be made while retaining the teachings of the invention. Accordingly, the above disclosure should be construed as limited only by the metes and bounds of the appended claims.

What is claimed is:

1. A mouse device with multimedia hotkeys comprising:
a mouse body;
a plurality of input portions for detecting movement of the mouse body and selecting computer functions by depressing the input portions;
a mouse motion tracking mechanism for moving the mouse body;
a circuit board for controlling operations of the mouse device;
a periphery interface for transmitting data processed by the circuit board to a computer; and
at least one multimedia hotkey mounted on the mouse body;
wherein when the multimedia hotkey is depressed, the data will be encoded by the circuit board and transmitted to the computer through the periphery interface, thereafter an associated multimedia program is executed.

2. The mouse device of claim 1 wherein the input portion comprises at least one general function key.

3. The mouse device of claim 1 wherein input portion further comprises a wheel axis.

4. The mouse device of claim 1 wherein the mouse motion tracking mechanism is a wheel ball with IR_PTR function, or an optical lens and sensor.

5. The mouse device of claim 1 wherein the periphery interface is a serial type, PS2, or USB connector.

6. The mouse device of claim 1 wherein the periphery interface is a wired or wireless interface.
